(19) United States
(12) Patent Application Publication
(10) Pub. No.: US 2019/0095430 A1
(43) Pub. Date: Mar. 28, 2019

(54) SPEECH TRANSLATION DEVICE AND ASSOCIATED METHOD

(71) Applicant: Google LLC, Mountain View, CA (US)

(72) Inventors: Boris Smus, Seattle, WA (US); Aaron Donsbach, Seattle, WA (US)

(73) Assignee: Google Inc., Mountain View, CA (US)

(21) Appl. No.: 15/714,548

(22) Filed: Sep. 25, 2017

(51) Int. Cl. G06F 17/28; G10L 13/04; H04R 1/40

(52) U.S. Cl. CPC G06F 17/289; H04R 1/406; G10L 13/043

(57) ABSTRACT

A computer-implemented method and associated computing device for translating speech can include receiving, at a microphone of a computing device, an audio signal representing speech of a user in a first language or in a second language at a first time. A positional relationship between the user and the computing device at the first time can be determined and utilized to determine whether the speech is in the first language or the second language. The method can further include obtaining, at the computing device, a machine translation of the speech represented by the audio signal based on the determined language, wherein the machine translation is: (i) in the second language when the determined language is the first language, or (ii) in the first language when the determined language is the second language. An audio representation of the machine translation can be output from a speaker of the computing device.

### FIELD

The present disclosure relates to a speech translation device, and more particularly, to a speech translation device that outputs an audio representation of a machine translation of received speech.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A typical translation device receives an input, such as text, in a first (or “source”) language and provides an output in a second (or “target”) language. User(s) of a typical translation device select the source and target languages and provide the inputs. In such translation devices, a language for each input is identified such that the translation device can operate appropriately, e.g., to obtain the proper translation from the source language to the target language. Accordingly, user(s) of such devices may be asked to input not only the item to be translated, but also various other information. For example, in situations in which two users speaking different languages utilize the translation device to communicate, the users taking turns must provide an input to switch between source and target languages for each turn in order for the input to be translated appropriately. It would be desirable to provide a translation device that allows user(s) to communicate more simply and intuitively.

### SUMMARY

A computer-implemented method for translating speech is disclosed. The method can include receiving, at a microphone of a computing device including one or more processors, an audio signal representing speech of a user in a first language or in a second language at a first time. A positional relationship between the user and the computing device at the first time can be determined and utilized to determine whether the speech is in the first language or the second language. The method can further include obtaining, at the computing device, a machine translation of the speech represented by the audio signal based on the determined language, wherein the machine translation is: (i) in the second language when the determined language is the first language, or (ii) in the first language when the determined language is the second language. An audio representation of the machine translation can be output from a speaker of the computing device.

In some aspects, determining the positional relationship between the user and the computing device can comprise detecting a change in position or orientation of the computing device based on an inertial measurement unit of the computing device. In such implementations, determining whether the speech is in the first language or the second language based on the determined positional relationship to obtain the determined language can comprise determining a most recent language corresponding to a most recently received audio signal preceding the first time, and switching from the most recent language to the determined language such that the determined language is: (i) the second language when the most recent language is the first language, or (ii) the first language when the most recent language is the second language.

In additional or alternative implementations, the microphone of the computing device can comprise a beamforming microphone array comprising a plurality of directional microphones. In such examples, receiving the audio signal representing speech of the user can include receiving an audio channel signal at each of the plurality of directional microphones. Further, determining the positional relationship between the user and the computing device can comprise determining a direction to the user from the computing device based on the audio channel signals and determining whether the speech is in the first language or the second language can be based on the determined direction. In some aspects, the method can further include associating, at the computing device, the first language with a first direction and the second language with a second direction, wherein determining whether the speech is in the first language or the second language based on the determined direction comprises comparing the determined direction to the first direction and second direction and selecting the first language or the second language based on the comparison.

In some aspects, obtaining the machine translation of the speech represented by the audio signal can comprise obtaining a confidence score indicative of a degree of accuracy that the machine translation accurately represents an appropriate translation of the audio signal, and the method can further comprise outputting an indication of the confidence score. For example only, the indication of the confidence score can be output only when the confidence score fails to satisfy a confidence threshold. Outputting the indication of the confidence score can comprise modifying the audio representation of the machine translation in some implementations, wherein modifying the audio representation of the machine translation can comprise modifying at least one of a pitch, tone, emphasis, inflection, intonation, and clarity of the audio representation.

In yet further examples, determining whether the speech is in the first language or the second language can be alternatively or further based on audio characteristics of the audio signal, the audio characteristics comprising at least one of intonation, frequency, timbre, and inflection.

In addition to the above, the present disclosure is directed to a computing device and a computing system for performing the above methods. Also disclosed is a non-transitory computer-readable storage medium having a plurality of instructions stored thereon, which, when executed by one or more processors, cause the one or more processors to perform the operations of the above methods.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system including an example computing device and an example server computing device according to some implementations of the present disclosure;

FIG. 2 is a functional block diagram of the example computing device of FIG. 1;

FIGS. 3A and 3B are illustrations of a communication session between two users utilizing an example computing device according to some implementations of the present disclosure;

FIG. 4 is another illustration of a communication session between users utilizing an example computing device according to some implementations of the present disclosure;

FIG. 5 is an illustration of an example computing device outputting an audio representation of a machine translation of a speech input according to some implementations of the present disclosure; and

FIG. 6 is a flow diagram of an example method for translating speech according to some implementations of the present disclosure.

### DETAILED DESCRIPTION

As briefly mentioned above, typical translation devices may require a user to provide information in addition to the input to be translated, e.g., an identification of the source and target languages for each input. The users of such translation devices may then be encumbered by interacting with the translation device more often than the other user(s) with which they are communicating. Even if the translation device is not at the center of the interaction between users, the translation device may nonetheless occupy a prominent role during the communication session. Such a prominent role for the translation device tends to make the communication between users delayed, awkward, or otherwise unnatural as compared to typical user communication.

Furthermore, the provision of such additional inputs in order for typical translation devices to operate properly may provide technical disadvantages for the translation device. For example only, such translation devices may be required to include additional user interfaces (such as, additional buttons or additional displayed graphical user interfaces) in order to receive the additional input. Furthermore, the additional input must be processed, thereby requiring additional computing resources, such as battery power and/or processor instruction cycles. Even in the event that the translation device can determine a source language from the input directly, such as with a detect language option for textual input, the translation device must first utilize battery power, processing power, etc. to detect the source language of the input before then moving to the translation operation.

It would be desirable to provide a translation device in which the source and target languages can be determined for an input in a more intuitive and less computationally expensive manner.

Accordingly, the present disclosure is directed to a computing device (and associated computer-implemented method) that receives an audio signal representing speech of a user and outputs an audio representation of a machine translation of the speech. In contrast to typical translation devices, a positional relationship between the user that provided the speech input and the computing device is determined and utilized to determine the source language of the speech input. For example only, if the computing device is relatively small (e.g., a mobile phone or other handheld device), two users utilizing the computing device may pass the computing device to, or orient the computing device towards, the user that is speaking. In this manner, the computing device may utilize the change in position or orientation, e.g., detected by an inertial measurement unit of the computing device, to assist in determining the source language of the speech input.

In alternative or additional examples, a beamforming microphone array may be utilized to detect/determine a direction from the computing device to the user that provided the speech input. The computing device may associate each user and her/his preferred language with a different direction. By comparing the determined direction to the directions associated with the users, the computing device can select the source language of the speech input. Other techniques for determining the positional relationship between the user that provided the speech input and the computing device are within the scope of the present disclosure.

Alternatively or in addition to utilizing the positional relationship between the user that provided the speech input and the computing device, the determination of the source language of the speech input can be based on audio characteristics of the speech input. In contrast to techniques in which a language is directly detected in speech, which may require complex language detection models that have a high computational cost, the present disclosure can detect and utilize simpler features of the speech/audio signal to determine a particular speaker and, therefore, the language of the speech input. Examples of these audio characteristics include, but are not limited to, the intonation, frequency, timbre, and inflection of the speech input.

For example only, the primary user of the computing device (such as, the owner of the mobile phone) may have a user profile at the computing device in which her/his preferred language is stored. Further, the primary user may also have certain particular audio characteristics to his/her speech, such as a particular intonation, frequency, timbre, and/or inflection, which may be easily detected from an audio signal representing her/his speech. Accordingly, these audio characteristics may be utilized to determine that the speech input corresponds to the primary user and, therefore, is in her/his preferred language. In this manner, the computing device can determine the source language from the audio characteristics of a speech input. It should be appreciated that audio characteristics other than those discussed above are within the scope of the present disclosure.

Additionally, machine translation of a speech input can be a relatively complex computational task that may be subject to ambiguities. In some cases, a speech input is received and a speech recognition or speech-to-text algorithm is utilized to detect the words/phrases/etc. in the source language. Such speech recognition algorithms typically take the form of a machine learning model that may output one or more possible speech recognition results, e.g., a most likely speech recognition result. The speech recognition result(s) may then be processed by a machine translation system that—similarly—may be a machine learning model that outputs one or more possible translation results, e.g., a most likely translation result. Finally, a text-to-speech algorithm may be utilized to output the translation result(s).

In each of the above algorithms/models, there may be an associated probability or score that is indicative of the likelihood that the model has provided the “correct” output, that is, has detected the appropriate words, translated the speech appropriately, and output the appropriate translated speech. In some translation devices, a plurality of outputs are provided (e.g., in a ranked order) to compensate for potential recognition errors in the models. This may be impractical, however, when the translation device desires to provide an audio representation of the machine translation during a conversation between users as this would be awkward and potentially confusing.

In accordance with some aspects of the present disclosure, the disclosed computing device and method can determine a confidence score indicative of a degree of accuracy that the machine translation accurately represents an appropriate translation of the speech input. The confidence score can, e.g., be based on one or more of the associated probabilities or scores indicative of the likelihood that the utilized model(s) has provided the “correct” output, as described above. In some aspects, an indication of the confidence score may be output by the computing device to assist the users in communication, as more fully described below.

For example only, the computing device may select and output an audio representation of the most likely machine translation for the speech input. This most likely machine translation may have an associated confidence score that is indicative of the likelihood that the machine translation accurately represents an appropriate translation of the speech input. When the confidence score fails to satisfy a confidence threshold, the computing device may output an indication of the confidence score to signal to the users that there may be a potential translation error in the output.

The indication of the confidence score can take many different forms. For example only, in the situation where the computing device has a display or other form of visual output device, the computing device may output a visual signal of the confidence score. As a non-limiting example, the computing device may provide a color based indication of the confidence level of the output, where a green output indicates a high confidence score, yellow an intermediate confidence score, and red a low confidence score.

In some implementations, the computing device may modify the audio representation of the machine translation that it outputs to indicate the confidence score. For example only, if the confidence score fails to meet a confidence threshold, the computing device may modify the pitch, tone, emphasis, inflection, intonation, clarity, etc. of the audio output to indicate a possible error and/or low confidence score.

When speaking the English language, it may be common for a speaker to naturally raise his or her voice to indicate a question or confusion. Similarly, when an English speaker is making a confident statement, the pitch of the speaker's voice may drop. In each case, a listener may, even without realizing it, detect the rise/drop of the speaker's voice and process the speech and these verbal clues accordingly. The present disclosure contemplates modifying the audio output of the machine translation to provide an audio indication that the computing device may not be as confident in the machine translation of a specific word, sentence, phrase, or other portion of the machine translation. For example only, if the confidence level of a specific word of the machine translation fails to satisfy the confidence threshold, the computing device may modify the audio output by raising the pitch of that word to indicate a question.

As mentioned above, the computing device and method of the present disclosure may have many technical advantages over known translation devices. The disclosed computing device may reduce the number of inputs required to obtain a desired output. Further, the disclosed computing device and method can achieve the desired output while expending less computational and battery power due to the lower complexity of the tasks compared to typical translation devices. Other technical advantages will be readily appreciated by one skilled in the art.

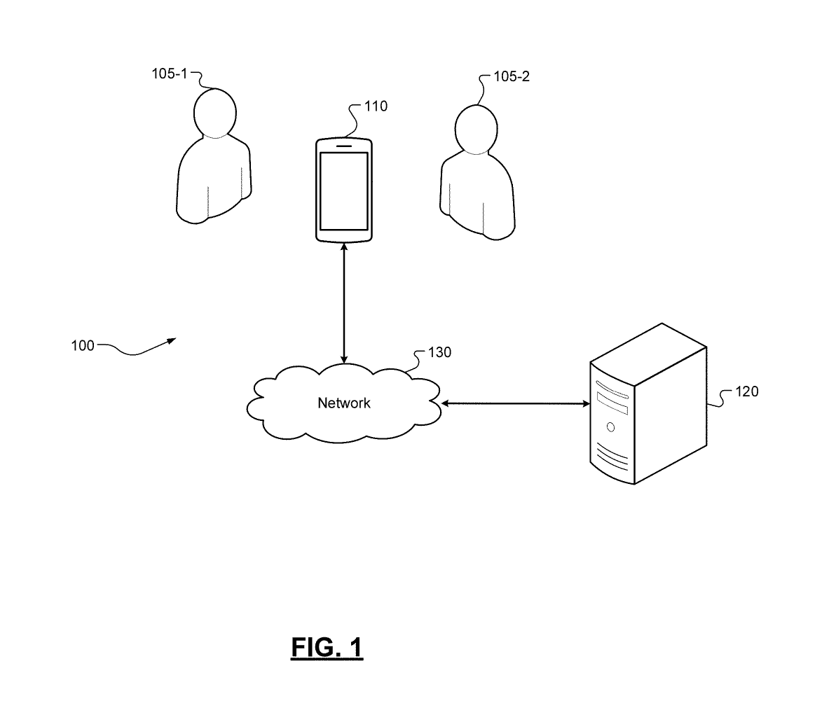

Referring now to FIG. 1, a diagram of an example computing system 100 is illustrated. The computing system 100 can be configured to implement a speech translation method that permits a plurality of users to communicate. The computing system 100 can include one or more computing devices 110 and an example server 120 that communicate via a network 130 according to some implementations of the present disclosure.

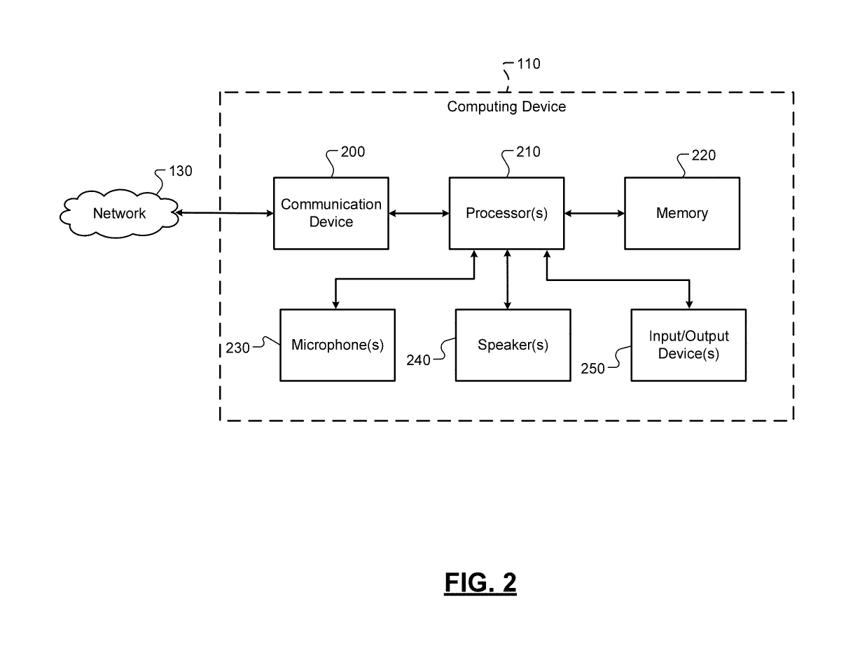

For ease of description, in this application and as shown in FIG. 1, one computing device 110 is illustrated and described as facilitating communication between a first user 105-1 and a second user 105-2 (referred to herein, individually and collectively, as “user(s) 105”). While illustrated as a mobile phone (“smart” phone), the computing device 110 can be any type of suitable computing device, such as a desktop computer, a tablet computer, a laptop computer, a wearable computing device such as eyewear, a watch or other piece of jewelry, clothing that incorporates a computing device, a smart speaker, or a special purpose translation computing device. A functional block diagram of an example computing device 110 is illustrated in FIG. 2.

The computing device 110 can include a communication device 200, one more processors 210, a memory 220, one or more microphones 230, one or more speakers 240, and one or more additional input/output device(s) 250. The processor(s) 210 can control operation of the computing device 110, including implementing at least a portion of the techniques of the present disclosure. The term “processor” as used herein is intended to refer to both a single processor and multiple processors operating together, e.g., in a parallel or distributed architecture.

The communication device 200 can be configured for communication with other devices (e.g., the server 120 or other computing devices) via the network 130. One non-limiting example of the communication device 200 is a transceiver, although other forms of hardware are within the scope of the present disclosure. The memory 220 can be any suitable storage medium (flash, hard disk, etc.) configured to store information. For example, the memory 220 may store a set of instructions that are executable by the processor 210, which cause the computing device 110 to perform operations, e.g., such as the operations of the present disclosure. The microphone(s) 230 can take the form of any device configured to accept and convert an audio input to an electronic signal. Similarly, the speaker(s) 240 can take the form of any device configured to accept and convert an electronic signal to output an audio output.

The input/output device(s) 250 can comprise any number of additional input and/or output devices, including additional sensor(s) (such as an inertial measurement unit), lights, displays, and communication modules. For example only, the input/output device(s) 250 can include a display device that can display information to the user(s) 105. In some implementations, the display device can comprise a touch-sensitive display device (such as a capacitive touchscreen and the like), although non-touch display devices are within the scope of the present disclosure.

It should be appreciated that the example server computing device 120 can include the same or similar components as the computing device 110, and thus can be configured to perform some or all of the techniques of the present disclosure, which are described more fully below. Further, while the techniques of the present disclosure are described herein in the context of a computing device 110, it is specifically contemplated that each feature of the techniques may be performed by a computing device 110 alone, a plurality of computing devices 110 operating together, a server computing device 120 alone, a plurality of server computing devices 120 operating together, and a combination of one or more computing devices 110 and one or more server computing devices 120 operating together.

The computing device 110 can also include one or more machine learning models. Such machine learning models can be a probability distribution over a sequence of inputs (characters, word, phrases, etc.) that is derived from (or “trained” based on) training data. In some implementations, a model can assign a probability to an unknown token based on known input(s) and a corpus of training data upon which the model is trained. The use of such a labeled training corpus or set can be referred to as a supervised learning process. Examples of incorporated machine learning models include, but are not limited to, a speech recognition or speech-to-text model, a machine translation model or system (such as a statistical machine translation system), a language model, and a text-to-speech model. Although not specifically illustrated as separate elements, it should be appreciated that the various models can comprise separate components of the computing device 110 and/or be partially or wholly implemented by processor 210 and/or the memory 220 (e.g., a database storing the parameters of the various models).

As mentioned above, the computing device 110 of the present disclosure determines the source language of a speech input of a user 105 based on various factors. As opposed to requiring a user 105 to specifically input the source language or running a complex language detection algorithm to detect the language for each speech input, the present disclosure can utilize a positional relationship between the user 105 and the computing device 110 and/or audio characteristics of the audio signal representing the speech input to determine the source language, as more full described below.

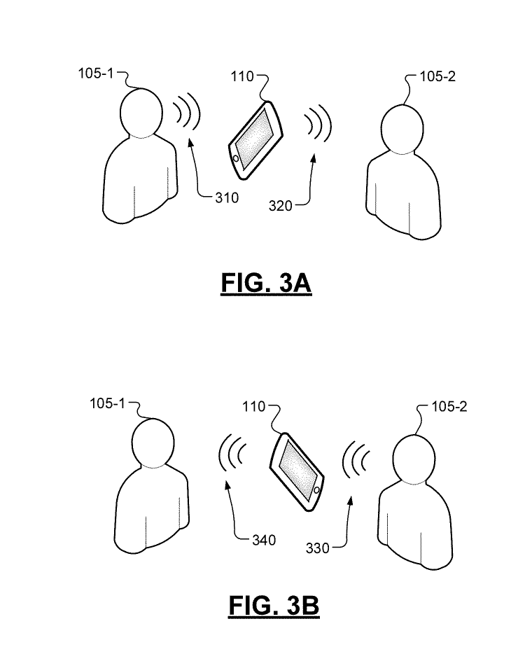

According to some aspects of the present disclosure, a conversation between a first user 105-1 and a second user 105-2 utilizing the computing device 110 as a translation device is portrayed in FIGS. 3A-3B. The first user 105-1 may communicate in a first language, and the second user 105-2 may communicate in a second language, wherein the computing device 110 translates the first language to the second language and vice-versa to facilitate the conversation. The conversation illustrated in FIGS. 3A-3B is shown as utilizing a mobile computing device 110 that can be easily moved, repositioned or reoriented between the users 105, but it should be appreciated that the computing device 110 can take any form, as mentioned above. The computing device 110 can, e.g., execute a translation application that receives an audio signal representing speech and that outputs an audio representation of a machine translation of the speech, as more fully described below.

For example only, the computing device 110 can receive a user input to begin executing a translation application and can receive an initial input of the first and second languages of the users 105. This initial configuration of the computing device 110 and translation application can be accomplished in various ways. As one example, the users 105 can directly provide a configuration input that selects the first and second languages. In another example, the computing device 110 can utilize user settings or user profiles of one or both of the users 105 to determine the first and second languages. Alternatively or additionally, the computing device 110 can utilize a language detection algorithm to identify the first and second languages in a subset of initial speech inputs. It should be appreciated that the initial configuration of the computing device 110/translation application can be performed in any known manner.

In the illustrated conversation, the first user 105-1 can provide speech input in the first language, which can be translated into the second language and output, e.g., via a speaker 240. Similarly, the second user 105-2 can provide speech input in the second language, which can be translated into the first language and output. Although only first and second users 105 are described in this example, it should be appreciated that the present disclosure can be utilized, mutatis mutandis, with any number of users 105. Furthermore, the present disclosure contemplates the use of an initial training or configuration process through which the user(s) 105 can learn to appropriately interact with the computing device 110 in order to trigger the switching of the source and target languages between the first and second languages. Such an initial training process can, e.g., be output by the computing device 110 via a display or other form of visual output device of the computing device 110, an audio output from the speaker(s) 240, or a combination thereof.

As shown in FIG. 3A, the computing device 110 is in a first position/orientation that is suited for receiving a first audio signal 310 representing speech of the first user 105-1. Assuming that the computing device 110 has been initially configured or otherwise determines that the audio signal 310 is in the first language, as described above, the computing device can obtain a machine translation of the speech represented by the audio signal 310 to the second language. An audio representation 320 of the machine translation can be output, e.g., from the speaker 240 of the computing device 110.

The computing device 110 can obtain a machine translation of the speech input in various ways. In some implementations, the computing device 110 can perform machine translation directly utilizing a machine translation model stored and executed at the computing device 110. In other implementations, the computing device 110 can utilize a machine translation model stored and executed remotely, e.g., at a server 120 in communication with the computing device 110 through a network 130. In yet further implementations, the computing device 110 can obtain a machine translation by executing the tasks of machine translation in conjunction with a server 120 or other computing devices, such that certain tasks of machine translation are directly performed by the computing device 110 and other tasks are offloaded to other computing devices (e.g., server 120). All of these implementations are within the scope of the present disclosure.

Examples of machine translation models include, but are not limited to, a statistical machine translation model, a hybrid machine translation model that utilizes multiple different machine translation models, a neural machine translation model, or a combination thereof. Further, additional models may be utilized in order to receive and output speech, e.g., speech-to-text models, text-to-speech models, language models and others. For example only, an audio signal representing speech can first be processed by a speech-to-text model that outputs text corresponding to the speech. The text can then be processed by a machine translation model, which outputs machine translated text. The machine translated text can be processed by a text-to-speech model, which outputs an audio representation of the machine translation. For ease of description, the present disclosure will utilize the term machine translation model to encompass and include any and all of the models required or beneficial to obtaining an audio output of a machine translation of a speech input.

As shown in FIG. 3B, the computing device 110 has been moved or reoriented to a second position/orientation that is suited for receiving a second audio signal 330 representing speech of the first user 105-2. The computing device 110 can detect a change in its position/orientation, e.g., based on an additional input/output device(s) 250 (an inertial measurement unit, accelerometer, gyroscope, camera, position sensor, etc.) of the computing device 110. In some aspects, the computing device 110 can include a predetermined tilt angle threshold or movement threshold that is met to detect that the computing device 110 has been moved or reoriented to the second position/orientation. In this manner, the computing device 110 can determine a positional relationship between the speaking user (in this figure, the speaking user is second user 105-2). This positional relationship can be utilized to determine whether the speech is in the first language or the second language.

For example only, if the second audio signal 330 is received at a first time, the computing device 110 can determine a most recent language corresponding to a most recently received audio signal preceding the first time. In this example, and as described above in relation to FIG. 3A, the most recent language preceding the first time corresponds to the first audio signal 310, which was determined to be in the first language. Upon detecting the change in its position/orientation, the computing device 110 can switch from the first language to the second language such that the computing device 110 can determine that the second audio signal 330 is in the second language. The computing device can obtain a machine translation of the speech represented by the second audio signal 330 to the first language and an audio representation 340 of the machine translation can be output, e.g., from the speaker 240 of the computing device 110.

As mentioned above, the computing device 110 can include a predetermined tilt angle threshold or movement threshold that is met to trigger the detection of the transition of the computing device 110 from the first position/orientation to the moved or reoriented second position/orientation. For example only, the predetermined tilt angle threshold or movement threshold can be set to be a specific number of degrees (such as, 110-150 degrees) corresponding to a change in the position/orientation of the computing device 100. In such examples, changes in the position/orientation of the computing device 110 that do satisfy such a threshold trigger a switch of source and target languages, as described herein, while changes in the position/orientation of the computing device 110 that do not satisfy such a threshold triggering do not. In some implementations, a notification can be output by the computing device 110 upon a switch of source and target languages. Examples of such notifications include, but are not limited to, an audio output, a visual indication (flashing light, color change of output light, etc.), a haptic feedback (vibration), and a combination thereof.

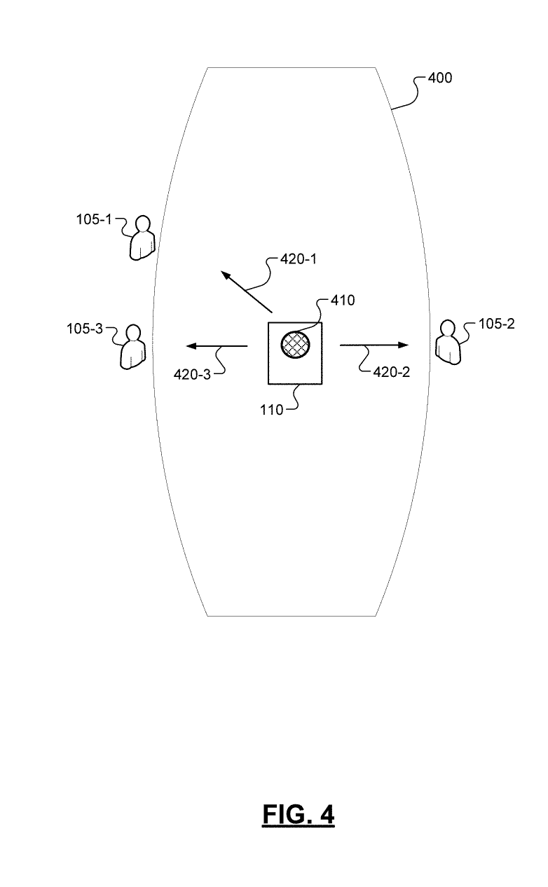

In some aspects, the microphone 230 of the computing device 110 can include a beamforming microphone array 410 that includes a plurality of directional microphones. For example only, and as illustrated in FIG. 4, the computing device 110 can take the form of a smart speaker device or conferencing device that includes the beamforming microphone array 410 and is arranged on a conference table 400. The computing device 110 can receive the audio signal representing a speech input by receiving an audio channel signal at each of the plurality of directional microphones of the beamforming microphone array 410. The microphone array 410/computing device 110 can reconstruct the audio signal by combining the audio channel signals, as is known. Further, the microphone array 410/computing device 110 can determine a direction to the source of the input (e.g., the user 105 providing the speech input) based on the audio channel signals. The determined direction can be utilized to determine the positional relationship between the user 105 who provided the speech input and the computing device 110, which can be utilized to determine the language of the speech input.

As shown in FIG. 4, the computing device can determine one of a first direction 420-1 to a first user 105-1, a second direction 420-2 to a second user 105-2, and a third direction 420-3 to a third user 105-3, wherein each of these determined directions can correspond to the direction of the particular user 105 that provided the speech input. The computing device 110 may be initially configured by receiving an initial input of the languages in which each of the users 105 will speak. As described above, this initial configuration of the computing device 110 can be accomplished in various ways. As one example, the users 105 can directly provide a configuration input that selects their corresponding languages. In another example, the computing device 110 can utilize user settings or user profiles of one or more of the users 105 to determine the languages. Alternatively or additionally, the computing device 110 can utilize a language detection algorithm to identify the language in initial speech inputs, which can be stored and utilized for later speech inputs. It should be appreciated that the initial configuration of the computing device 110 can be performed in any known manner.

Upon being configured, the computing device 110 can associate each of the directions 420 with the language of its corresponding user 105, e.g., a first language can be associated with the first direction 420-1, a second language can be associated with the second direction 420-2, and a third language can be associated with the third direction 420-3. When an audio signal representing speech is received at the microphone array 410, a direction 420 to the user 105 that spoke may be determined and compared to first, second, and third directions 420 associated with the users 105. Based on this comparison, the particular language associated with the detected direction 420 may be selected as the source language of the speech input. The other language(s) can be selected as the target language(s) in which an audio representation of the machine translation is output.

In further implementations, the computing device 110 may include additional position sensors as part of the input/output device 250. For example only, the computing device 110 may include a camera, a motion detector (for detecting lip movement), or other input/output device 250 that can assist in determining the positional relationship between the speaking user 105 and the computing device 110.

As mentioned above, the computing device 110 can obtain a machine translation of the speech input in various ways. In some implementations, the computing device 110 can obtain a confidence score indicative of a degree of accuracy that the machine translation accurately represents an appropriate translation of the audio signal. The confidence score can, e.g., be based on one or more of the associated probabilities or scores indicative of the likelihood that the utilized model(s) has provided the “correct” output, as described above. The computing device 110 can also output an indication of the confidence score such that users 105 may be informed as to the likelihood that the output machine translation is appropriate.

In some aspects, the indication of the confidence score is output only when the confidence score fails to satisfy a confidence threshold. The confidence threshold can, e.g., represent a threshold that the machine translation model has determined to represent a relatively high degree of accuracy, although any suitable threshold may be utilized. As mentioned above, the indication of the confidence score can take many different forms, e.g., a visual signal such as a color based indication of the confidence level of the output, where a green output indicates a high confidence score, yellow an intermediate confidence score, and red a low confidence score.

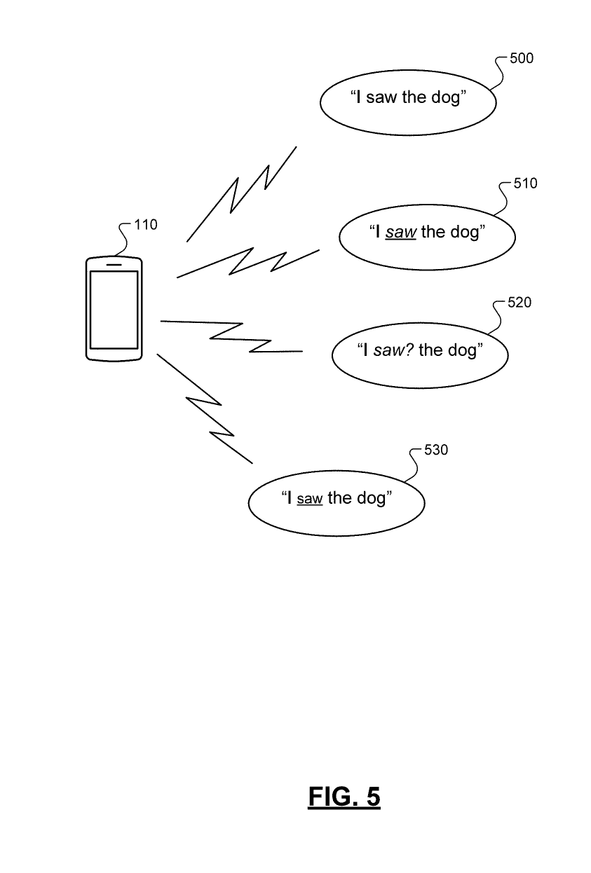

In some implementations, and as illustrated in FIG. 5, the computing device 110 may modify the audio representation of the machine translation that it outputs to indicate the confidence score. For example only, if the confidence score fails to satisfy a confidence threshold, the computing device may modify at least one of a pitch, tone, emphasis, inflection, intonation, and clarity of the audio representation to indicate a possible error and/or low confidence score. In FIG. 5, four versions of the audio representation of the machine translation are illustrated. In the first version, the audio representation 500 is “I saw the dog” in the normal pitch, tone, etc. for the audio output. The audio representation 500 may, e.g., be output by the computing device 110 when the confidence score satisfies the confidence threshold discussed above.

In the second version, the audio representation 510 is “I saw the dog” in which the audio representation 500 has been modified by emphasizing the word “saw” in order provide an indication of the confidence score. For example only, the confidence score for audio representation 510 may not have satisfied the confidence threshold. Accordingly, the computing device 110 has modified the audio representation 500 in order to provide a signal to the users 105 that the machine translation may not be accurate or appropriate.

Similarly, in the third version, the audio representation 520 is “I saw? the dog” in which the audio representation 500 has been modified by modifying the pitch or tone of the word “saw” to provide an indication of the confidence score. As mentioned above, when speaking the English language, it may be common for a speaker to naturally raise his or her voice to indicate a question or confusion. Accordingly, the computing device 110 can modify the audio representation 500 of the machine translation to mimic the natural raising of voice in order to provide an audio indication of the confidence score. In the fourth version, the audio representation 530 is “I saw the dog” in which the audio representation 500 has been modified by modifying the volume or clarity of the word “saw” (illustrated as representing “saw” in a smaller font) to provide an indication of the confidence score. Other forms of providing an indication are contemplated by the present disclosure.

According to some aspects of the present disclosure, determining the language (source language) of an audio signal representing speech of a user 105 can be based on the audio characteristics of the audio signal, as mentioned above. The utilization of the audio characteristics of the audio signal can be used in addition to or as an alternative to utilizing the positional relationship between the user 105 that provided the speech input and the computing device 110 described above.

Each user 105 may have certain particular audio characteristics to his/her speech, such as a particular intonation, frequency, timbre, and/or inflection. Such audio characteristics may be easily detected from an audio signal representation of speech and leveraged to identify the source language of the speech. For example only, a user 105 of the computing device 110 may have a user profile in which her/his preferred language and audio characteristics of speech are stored. Accordingly, when the computing device 110 receives a speech input from the user 105, the audio characteristics can be detected and matched to the user 105 in order to identify the source language of the speech as the preferred language of the user 105.

Alternatively or additionally, the computing device 110 can receive a user input to begin executing a translation application and can receive an initial input of the specific languages of the users 105. As mentioned above, the initial configuration of the computing device 110 and translation application can be accomplished in various ways. As one example, the users 105 can directly provide a configuration input that selects the languages. In another example, the computing device 110 can utilize a language detection algorithm to identify the languages of the users 105 in a subset of initial speech inputs, which can be utilized to determine the language of the speech input. Certain audio characteristics can be detected from these initial speech inputs and associated with particular languages. In this manner, the computing device 100 may then utilize these simpler audio characteristics to detect speech of specific users 105 and their associated language. It should be appreciated that the initial configuration of the computing device 110/translation application can be performed in any known manner.

The audio characteristics described herein can specifically exclude the content of the speech input itself, that is, the language and words in the speech input. As mentioned above, techniques in which a language is directly detected in speech may require complex language detection models that have a high computational cost. Although such language detection models can be utilized with the present disclosure (e.g., during the initial configuration of the computing device 110), the present disclosure contemplates that the audio characteristics comprise simpler features of the speech/audio signal to determine a particular user 105 and, therefore, the language of the speech input. These simpler features include, but are not limited to, a particular intonation, frequency, timbre, and/or inflection of the speech input.

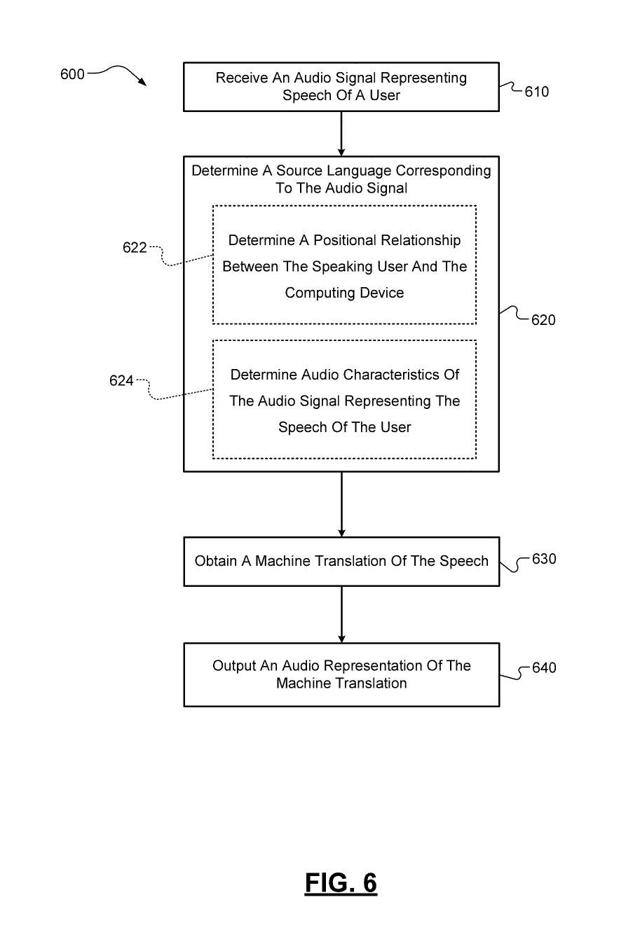

Referring now to FIG. 6, a flow diagram of an example method 600 for translating speech is illustrated. While the technique 600 will be described below as being performed by a computing device 110, it should be appreciated that the method 600 can be performed, in whole or in part, at another or more than one computing device 110 and/or the server computing device 120 described above.

At 610, the computing device 110 can receive at a microphone 230 an audio signal representing speech of a user 150 in a first language or in a second language at a first time. At 620, the computing device 110 can determine a source language corresponding to the audio signal, e.g., whether the speech is in the first language or the second language. The determination of the source language corresponding to the audio signal can be based on various factors. For example only, at 622, the computing device 110 can determine a positional relationship between the speaking user 105 and the computing device 110. As described above, the positional relationship can be determined by detecting a change in position or orientation of the computing device 110 (see FIGS. 3A-3B), by determining a direction to the user 105 from the computing device 110 (see FIG. 4), using additional input/output device(s) 250, a combination thereof, or any other method.

Alternatively or additionally, at 624, the computing device 110 can determine audio characteristics of the audio signal representing the speech of the user 105. These audio characteristics, such as a particular intonation, frequency, timbre, and/or inflection, can be easily detected from an audio signal representation of speech and leveraged to identify the source language of the speech, as described above.

The computing device 110 can obtain a machine translation of the speech represented by the audio signal based on the determined language at 630. As described above, the machine translation can be obtained from a machine translation model. When translating between languages, when the source language of the input audio signal is determined, the target language(s) into which the audio signal is to be translated can comprise the other languages previously utilized. At 640 the computing device 110 can output an audio representation of the machine translation from speaker 240.

Further to the descriptions above, a user may be provided with controls allowing the user to make an election as to both if and when systems, programs or features described herein may enable collection of user information (e.g., information about a user's current location, language preferences, speech characteristics), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a microphone of a computing device including one or more processors, an audio signal representing speech of a user in a first language or in a second language at a first time;
determining, at the computing device, a positional relationship between the user and the computing device at the first time;
determining, at the computing device, whether the speech is in the first language or the second language based on the determined positional relationship to obtain a determined language;
obtaining, at the computing device, a machine translation of the speech represented by the audio signal based on the determined language, wherein the machine translation is: (i) in the second language when the determined language is the first language, or (ii) in the first language when the determined language is the second language;
outputting, from a speaker of the computing device, an audio representation of the machine translation.

2. The computer-implemented method of claim 1, wherein determining the positional relationship between the user and the computing device comprises:
detect a change in position or orientation of the computing device based on an inertial measurement unit of the computing device.

3. The computer-implemented method of claim 2, wherein determining whether the speech is in the first language or the second language based on the determined positional relationship to obtain the determined language comprises:
determining a most recent language corresponding to a most recently received audio signal preceding the first time;
switching from the most recent language to the determined language such that the determined language is: (i) the second language when the most recent language is the first language, or (ii) the first language when the most recent language is the second language.

4. The computer-implemented method of claim 1, wherein:
the microphone comprises a beamforming microphone array comprising a plurality of directional microphones;
receiving the audio signal representing speech of the user comprises receiving an audio channel signal at each of the plurality of directional microphones;
determining the positional relationship between the user and the computing device comprises determining a direction to the user from the computing device based on the audio channel signals; and
determining whether the speech is in the first language or the second language is based on the determined direction.

5. The computer-implemented method of claim 4, further comprising associating, at the computing device, the first language with a first direction and the second language with a second direction, wherein determining whether the speech is in the first language or the second language based on the determined direction comprises comparing the determined direction to the first direction and second direction and selecting the first language or the second language based on the comparison.

6. The computer-implemented method of claim 1, wherein obtaining the machine translation of the speech represented by the audio signal comprises obtaining a confidence score indicative of a degree of accuracy that the machine translation accurately represents an appropriate translation of the audio signal, the method further comprising outputting an indication of the confidence score.

7. The computer-implemented method of claim 6, wherein the indication of the confidence score is output when the confidence score fails to satisfy a confidence threshold.

8. The computer-implemented method of claim 6, wherein outputting the indication of the confidence score comprises modifying the audio representation of the machine translation.

9. The computer-implemented method of claim 8, wherein modifying the audio representation of the machine translation comprises modifying at least one of a pitch, tone, emphasis, inflection, intonation, and clarity of the audio representation.

10. The computer-implemented method of claim 1, wherein determining whether the speech is in the first language or the second language is further based on audio characteristics of the audio signal, the audio characteristics comprising at least one of intonation, frequency, timbre, and inflection.

11. A computing device, comprising:
at least one microphone;
at least one speaker;
one or more processors; and
a non-transitory computer-readable storage medium having a plurality of instructions stored thereon, which, when executed by the one or more processors, cause the one or more processors to perform operations comprising:
receiving, at the at least one microphone, an audio signal representing speech of a user in a first language or in a second language at a first time;
determining a positional relationship between the user and the computing device at the first time;
determining whether the speech is in the first language or the second language based on the determined positional relationship to obtain a determined language;
obtaining a machine translation of the speech represented by the audio signal based on the determined language, wherein the machine translation is: (i) in the second language when the determined language is the first language, or (ii) in the first language when the determined language is the second language;
outputting, from the speaker, an audio representation of the machine translation.

12. The computing device of claim 11, wherein determining the positional relationship between the user and the computing device comprises:
detect a change in position or orientation of the computing device based on an inertial measurement unit of the computing device.

13. The computing device of claim 12, wherein determining whether the speech is in the first language or the second language based on the determined positional relationship to obtain the determined language comprises:
determining a most recent language corresponding to a most recently received audio signal preceding the first time;
switching from the most recent language to the determined language such that the determined language is: (i) the second language when the most recent language is the first language, or (ii) the first language when the most recent language is the second language.

14. The computing device of claim 11, wherein:
the at least one microphone comprises a beamforming microphone array comprising a plurality of directional microphones;
receiving the audio signal representing speech of the user comprises receiving an audio channel signal at each of the plurality of directional microphones;
determining the positional relationship between the user and the computing device comprises determining a direction to the user from the computing device based on the audio channel signals; and
determining whether the speech is in the first language or the second language is based on the determined direction.

15. The computing device of claim 14, wherein the operations further comprise associating the first language with a first direction and the second language with a second direction, wherein determining whether the speech is in the first language or the second language based on the determined direction comprises comparing the determined direction to the first direction and second direction and selecting the first language or the second language based on the comparison.

16. The computing device of claim 11, wherein obtaining the machine translation of the speech represented by the audio signal comprises obtaining a confidence score indicative of a degree of accuracy that the machine translation accurately represents an appropriate translation of the audio signal, the method further comprising outputting an indication of the confidence score.

17. The computing device of claim 16, wherein the indication of the confidence score is output when the confidence score fails to satisfy a confidence threshold.

18. The computing device of claim 16, wherein outputting the indication of the confidence score comprises modifying the audio representation of the machine translation.

19. The computing device of claim 18, wherein modifying the audio representation of the machine translation comprises modifying at least one of a pitch, tone, emphasis, inflection, intonation, and clarity of the audio representation.

20. The computing device of claim 11, wherein determining whether the speech is in the first language or the second language is further based on audio characteristics of the audio signal, the audio characteristics comprising at least one of intonation, frequency, timbre, and inflection.
